(19) United States
(12) Patent Application Publication
(10) Pub. No.: US 2009/0160820 A1
(43) Pub. Date: Jun. 25, 2009

(54) TOUCH PANEL WITH FUNCTION OF PREVENTING FAULT DETECTION

(76) Inventors: JIA-YIH LII, Hsin-Chu (TW); Yen-Chang Chiu, Hsin-Chu (TW); Min-Shu Wang, Hsin-Chu (TW); Han-Shu Lin, Hsin-Chu (TW)

Correspondence Address: G. LINK CO., LTD., 3550 BELL ROAD, MINOOKA, IL, 60447, US

(21) Appl. No.: 12/032,948

(22) Filed: Feb. 18, 2008

Related U.S. Application Data
(60) Provisional application No. 61/016,576, filed on Dec. 25, 2007.

(51) Int. Cl. G06F 3/045

(52) U.S. Cl. 345/174

(57) ABSTRACT

The present invention discloses a touch panel with function of preventing fault detection comprising a touch sensor and the outer peripheral area of the touch sensor is configured with at least one electrical lead. The present invention is characterized in having the conductive shield layer configured in a position corresponding to the outer peripheral area for preventing the fault detection by touching the outer peripheral area.

The application is a non-provisional application of Provisional Application No. 61/016,576 filed on Dec. 25, 2007.

### FIELD OF THE INVENTION

The present invention relates to a touch panel, and more specifically to a touch panel with function of preventing fault detection.

### BACKGROUND OF THE INVENTION

U.S. Pat. No. 6,819,316, titled “Flexible Capacitive Touch Sensor”, has disclosed to configure the electrical leads, the electrodes, and the conductive area in the outer peripheral area on a substrate, whose subject is to maximize the active area. The capacitive touch sensor disclosed in U.S. Pat. No. 6,819,316 has contributed for expanding the active area.

However, there will be some problems when applying the touch panel to the handheld products, such as mobile phones. The outer peripheral area of the touch panel will frequently occur with the touch fault. Thus, the inventor has worked hard for improvement to present a touch panel with function of preventing fault detection, so as to prevent the fault detection in the outer peripheral area.

### SUMMARY OF THE INVENTION

The object of the present invention is to provide a touch panel for preventing from the fault detection by touching the outer peripheral area.

To this end, the present invention provides a touch panel with function of preventing fault detection, which comprises a touch sensor, and the outer peripheral area of the touch sensor is configured with at least one electrical lead connected with the touch sensor. The present invention is characterized in having the conductive shield layer configured in a position corresponding to the outer peripheral area for preventing from the fault detection by the user's touch on the outer peripheral area.

### BRIEF DESCRIPTION OF THE DRAWINGS

The purpose and the effects of the present invention may be best understood by those skilled in the art by referring to the following detailed description of the preferred embodiments and the accompanying drawings, wherein:

FIG. 1 is an exploded structure diagram of a touch panel with function of preventing fault detection according to the present invention;

FIG. 2A is a structural diagram of a touch sensor employed by the touch panel according to the present invention;

FIG. 2B is a structural diagram of another type of touch sensor employed by the touch panel according to the present invention;

FIG. 3 is a structural cross-section view along the line 3-3 in FIG. 1 for the touch panel with function of preventing fault detection according to the present invention;

FIG. 4 is another embodiment of the conductive shield layer according to the present invention; and

FIG. 5 is an application of a mobile phone configured with the touch panel with function of preventing fault detection according to the present invention.

### DETAILED DESCRIPTION OF THE INVENTION

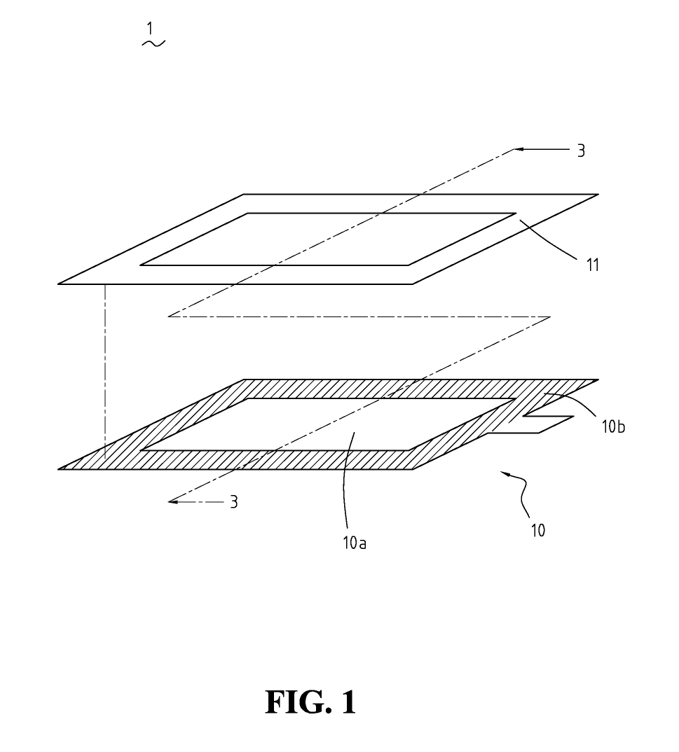

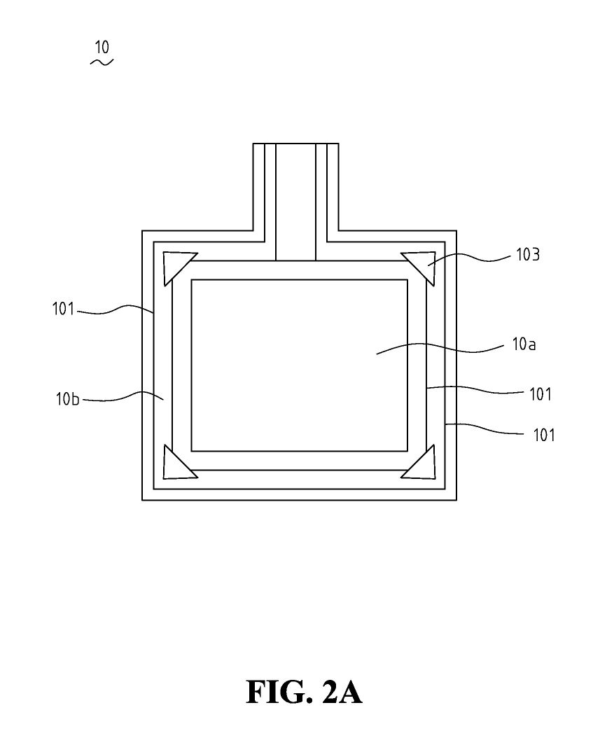

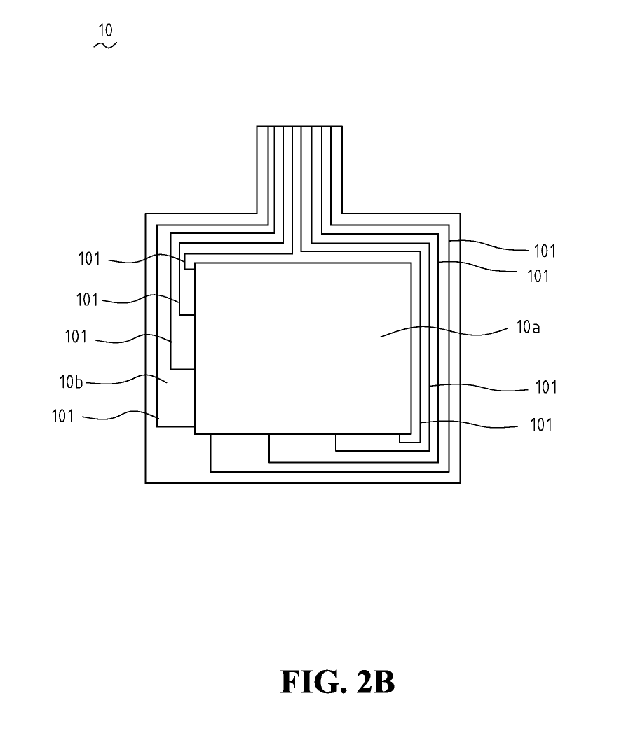

FIG. 1 is an exploded structure diagram of a touch panel with function of preventing fault detection according to the present invention. FIG. 2A is a structural diagram of a touch sensor employed by the touch panel according to the present invention, and FIG. 2B is a structural diagram of another type of touch sensor employed by the touch panel according to the present invention. The touch panel 1 with function of preventing fault detection according to the present invention comprises: a touch sensor 10 and a conductive shield layer 11, in which the shield layer 11 covers the outer peripheral area 10b of the touch sensor 10. As shown in FIG. 1, the hatched area is the outer peripheral area 10b. The touch sensor 10 may directly adopt the conventional touch sensor, such as the touch sensor disclosed in U.S. Pat. No. 6,819,316, or the conventional projected capacitive touch sensor.

Referring to FIG. 2A, because the touch sensor 10 is configured to maximize the area of the active area 10a, the electrical leads 101 and the electrodes 103 are configured within the outer peripheral area 10b. When an object, such as fingers, touched on the active area 10a, the touch sensor 10 will immediately detect the touch position, and transmit a two-dimensional coordinate signal corresponding to the touch position. Because the outer peripheral area 10b is configured with the electrical leads 101 and the electrodes 103, and the electrical leads 101 and the electrodes 103 are electrically connected with the active area 10a, when the user touched the peripheral position of the touch panel 1, it might be determined as touching the touch panel. However, the outer peripheral area 10b is not in the scope of the active area 10a, so that the touch in the outer peripheral area 10b will make the touch panel 1 produce fault detection. The conductive shield layer 11 according to the present invention provides a major function for preventing the touch panel 1 from occurring with such fault detection.

Referring to FIG. 2B, the projected capacitive touch sensor 10 provides the sensing units including X-axis and Y-axis within the active area 10a for detecting the touch position. The electrical leads 101 are configured within the outer peripheral area 10b. One end of the electrical leads 101 is used to connect with the sensing units within the active area 10a, and the other end is connected with a control chip (not shown). Under normal operation, the fingers of the user will operate within the active area 10a. However, when the user touched the peripheral position of the touch panel 1, for example touching the intersection of the outer peripheral area 10b and the active area 10a, although such a touch position is not in the scope of the active area 10a, the touch panel 1 will still possibly be activated. The major function of the conductive shield layer 11 according to the present invention is to prevent the touch panel 1 from occurring with such faults.

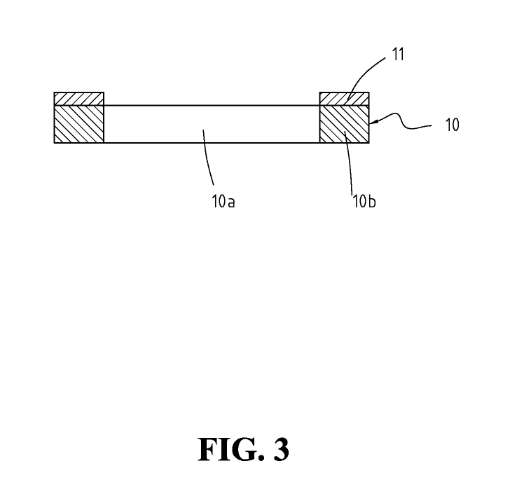

FIG. 3 shows a structural cross-section view along the line 3-3 in FIG. 1 for the touch panel with function of preventing fault detection according to the present invention. The conductive shield layer 11 is configured on the surface of the outer peripheral area 10b of the touch sensor 10. As shown in FIG. 2A, the shield layer 11 can be used to shield the electrical leads 101 and the electrodes 103 in the outer peripheral area 10b. If the shape for the layout of the electrical leads 101 and the electrodes 103 in the outer peripheral area 10b is a rectangular type, the shield layer 11 will employ a rectangular structure corresponding to the layout position of the electrical leads 101 and the electrodes 103. On the other hand, if the shape for the layout of the electrical leads 101 and the electrodes 103 in the outer peripheral area 10b is an U-shape, the shield layer 11 will employ an U-shape structure corresponding to the layout position of the electrical leads 101 and the electrodes 103. As shown in FIG. 2B, the shield layer 11 can shield the electrical leads 101 in the outer peripheral area 10b, and further shield a portion of array electrodes at the intersection of the active area 10a and the outer peripheral area 10b.

In FIG. 3, the implementation of the shield layer 11 may employ the conductive painting, such as conductive ink, to coat on the surface of the outer peripheral area 10b; or, attaching the conductive tape, metal sheet or metal mesh on the surface of the outer peripheral area 10b; or, forming a thin layer of transparent conductive film of Indium Tin Oxide on the surface of the outer peripheral area 10b.

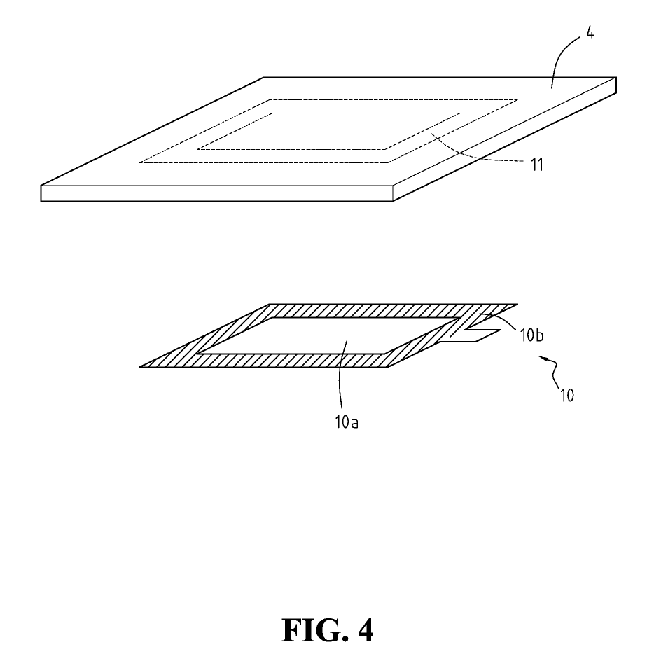

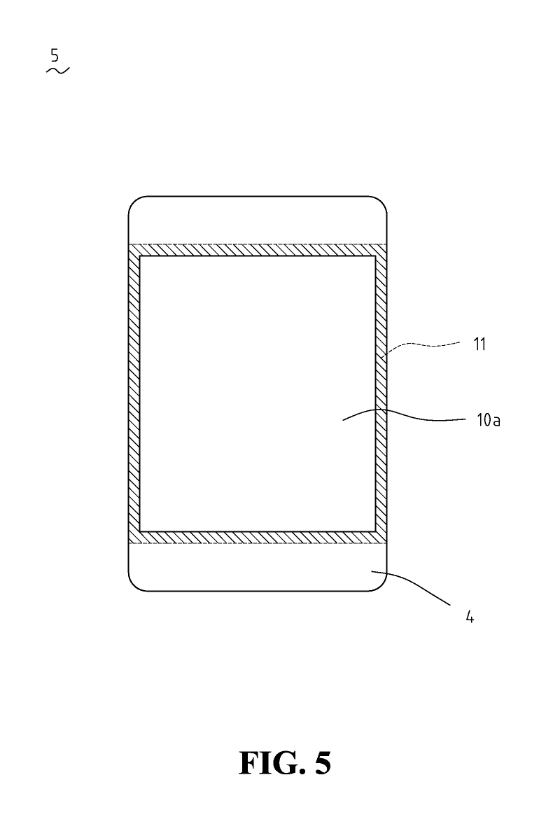

FIG. 4 provides another embodiment according to the present invention. The conductive shield layer 11 is located in the outer peripheral area on the inner surface of the case 4. And, the outer peripheral area on the inner surface of the case 4 is corresponding to the outer peripheral area 10b of the touch sensor 10. Referring to FIG. 5, making an example of a mobile phone 5 employing the touch panel with function of preventing fault detection according to the present invention, the case 4 is the case of the mobile phone 5, and the touch panel 1 is mounted within the case 4. The conductive shield layer 11 is located on the inner surface of the case 4, and corresponding to the outer peripheral area 10b of the touch sensor 10. In FIG. 5, the hatched area is the position for the conductive shield layer 11 on the inner surface of the case 4.

As shown in FIG. 4, the implementation for the shield layer 11 may employ the conductive painting, such as conductive ink, to coat on the surface of the outer peripheral area 10b; or, attaching the conductive tape, metal sheet or metal mesh on the outer peripheral area of the inner surface of the case 4.

As shown in FIG. 2A, if the shape for the layout of the electrical leads 101 and the electrodes 103 in the outer peripheral area 10b is a rectangular type, the shield layer 11 on the inner surface of the case 4 will employ a rectangular layout corresponding to the electrical leads 101 and the electrodes 103 in the outer peripheral area 10b. On the other hand, if the shape for the layout of the electrical leads 101 and the electrodes 103 in the outer peripheral area 10b is an U-shape, the shield layer 11 on the inner surface of the case 4 will employ an U-shape layout corresponding to the electrical leads 101 and the electrodes 103.

Similarly, as shown in FIG. 2B, the shape of the shield layer 11 on the inner surface of the case 4 is corresponding to the layout of the electrical leads 101, and, moreover, the shield layer 11 on the inner surface of the case 4 will further shield a portion of sensing units at the intersection of the active area 10a and the outer peripheral area 10b.

According to the art spirit of the present invention in FIG. 4, the conductive shield layer 11 is configured in the outer peripheral area corresponding to the touch sensor 10, and the conductive shield layer 11 is located between the touch sensor 11 and the case 4.

The shield layers 11 in FIG. 3 and FIG. 4 can be further connected to the ground potential to enhance the shielding effect.

The touch panel according to the present invention employs the conductive shield layer to prevent the fault detection by touching the outer peripheral area of the touch panel 1, which can improve the reliability of the touch panel.

The detailed descriptions of the above-mentioned preferred embodiments are used for clear description of the features and spirit of the present invention, but not limiting the scope of the present invention with the disclosed preferred embodiments. On the contrary, the object is to as far as possibly cover the various variations and the equivalent arrangements within the scope of the claims in the present invention.

What is claimed is:

1. A touch panel with function of preventing fault detection, wherein the touch panel comprises a touch sensor, and the outer peripheral area of the touch sensor is configured with at least one electrical lead, which is characterized in having a conductive shield layer configured in a position corresponding to the outer peripheral area.

2. The touch panel with function of preventing fault detection according to claim 1, wherein the conductive shield layer is formed on the surface of the outer peripheral area.

3. The touch panel with function of preventing fault detection according to claim 1, wherein the conductive shield layer is configured in the outer peripheral area on the inner surface of a case, and the outpour peripheral area on the inner surface of the case is corresponding to the outer peripheral area of the touch sensor.

4. The touch panel with function of preventing fault detection according to claim 1, wherein the conductive shield layer is further connected with the ground potential.

5. The touch panel with function of preventing fault detection according to claim 1, wherein the material of the conductive shield layer is selected one from the group composed of a conductive painting, a conductive tape, a metal sheet, a metal mesh, a transparent conductive film of Indium Tin Oxide.

6. The touch panel with function of preventing fault detection according to claim 1, wherein the conductive shield layer is configured in a position corresponding to the outer peripheral area, and the conductive shield layer is sandwiched between the touch sensor and a case.
